(19) United States
(12) Patent Application Publication
(10) Pub. No.: US 2010/0149483 A1
(43) Pub. Date: Jun. 17, 2010

(54) Optical Filter for Selectively Blocking Light

(76) Inventor: Stephen V. Chiavetta, III, Wilmington, NC (US)

Correspondence Address: ALSTON & BIRD LLP, BANK OF AMERICA PLAZA, 101 SOUTH TRYON STREET, SUITE 4000, CHARLOTTE, NC, 28280-4000, US

(21) Appl. No.: 12/333,792

(22) Filed: Dec. 12, 2008

(51) Int. Cl. G02C 7/10

(52) U.S. Cl. 351/163

(57) ABSTRACT

The present invention is directed to an optical filter that attenuates specific areas of the visible spectrum corresponding to the peaks of absorption of both the S-cone and rod cells within the human retina. The optical filter can be configured to also selectively block at least a portion of light centered at either one or both of the peak absorptive wavelengths of the human M and L-cone cells. The optical filter can be included within or on any optical system that is able to transmit all or part of the visible spectrum. As such, the present invention also provides an optical system that acts as a phototoxicity filter for the eye and can be used in conjunction with any material where visible light has at least partial transmittance.

### BACKGROUND OF THE INVENTION

1. Field of the Invention

The present invention relates generally to optical filters that selectively block light at specific wavelengths.

2. Description of Related Art

The eye absorbs and reacts to light energy from the electromagnetic spectrum to allow a visual experience to occur. The derivation of this visual experience comes from light activation of cone and rod cells within the retina of the eye. When light enters the eye, activation occurs when enough light energy lying within the different parabolic light absorption curves of the cone and rod cells causes a photochemical reaction in the retina. After the initial photochemical reactions, cells in the eye propagate the signals to other cells that then activate neurons. Subsequently, neural integration of the many different activated neurons creates an individual pattern of color and resolution in the brain that is vision.

The cone and rod cells that evolved for the eye did so in a well-designed manner. However, they needed to evolve in a way that created differences in absorptive sensitivity to light across a relatively narrow range of wavelengths for color to be appreciated. While these steep parabolic light absorption curves allow vision to be perceived in a wonderful myriad of colors, it also causes wide differences in absorptive sensitivity across a remarkably narrow range of different wavelengths. While nature may have dictated this was the easiest way for an organism to evolve into perceiving vision, the steep slopes of these absorption curves cause their peak absorptive wavelengths to potentially bleach the retina too easily under bright light (photopic) conditions. When the retina is bleached, unwanted and potentially phototoxic biochemical reactions can occur.

While the eye does have an impressive array of repair systems, it is believed that the higher energy short-wave (S) cones and rods are the two types of photoreceptors that are the most susceptible to damage (Meyers, Trans Am Ophthalmol Soc 2004;102:83-95). At the peak absorptive wavelengths of their two absorption curves, the stresses on the eye are unusually high for these two types of cells. Millions of years ago, when human life expectancy was only 35 to 40 years, these stresses may not have been detrimental to vision and propagation of the species. However, these stresses become a more significant problem now as the average human lifespan increases to 75 and 80 years of age and susceptibility to degenerations of the eye becomes more manifest.

As such, blue blocking filters have been developed in the past in an attempt to protect the eyes from harmful light rays. Unfortunately, these filters have never attempted to block light specifically within the areas of peak absorption for the S cones and rods where the eye is most vulnerable to phototoxic damage. Instead they have always been “blue-blockers” in the purest sense of the words and have non-specifically attenuated light from the higher energy blue region rather than specifically attempting to modify the photoreceptor absorption curves.

For example, U.S. Patent Publication No. 2007/0216861 describes a variation of a typical “blue-blocker” in which light filtration is centered only at 450 nm where they feel maximal damage from visible light may occur. Similarly, U.S. Patent Publication No. 2008/0186448 centers light filtration only at 430 nm. With both of these publications, the central areas of blockage are only the integrated average of where they feel phototoxic reactions can occur. Peak damage actually occurs in a bimodal distribution centered around both the 420 nm and 498 nm regions at the apex of the S cone and rod absorption curves. Blocking the peak absorption wavelengths of the S cones and the rods creates a true double notch phototoxicity filter instead of a single global “blue-blocker.” The bimodal distribution of this phototoxicity is not new science (Meyers, Trans Am Ophthalmol Soc 2004;102:83-95), but filtering light based on this bimodal distribution and the S-cone and rod absorption curves has not been recognized prior to the present invention.

While blocking the sensitivity peaks of the S-cones and the rods is important, it should be remembered that at least some absorption of light in the short-wave range is important in order to help regulate circadian rhythms and decrease risks for clinical depression. Thus, except in special cases, it is better to only partially filter these two peaks and the surrounding areas under the absorption curves rather than eliminate all of the light around a particular wavelength.

Additionally, it is important to evaluate not just the protective effect of blocking the apex of the S-cone and rod cell absorption curves, but the real time visual result as well. Accordingly, evaluation of color discrimination should be part of the analysis of any optical system designed to affect light entering the eye. Preferably, an optical filter should not negatively affect the ability to discern color.

Accordingly, there remains a need for an optical system that selectively blocks a portion of the light centered at the peak absorptive wavelengths of the human S-cone cells and the rod cells. Furthermore, there also remains a need for such an optical system that does not negatively affect color discernment.

### BRIEF SUMMARY OF THE INVENTION

The present invention satisfies at least some of the aforementioned needs by providing an optical filter or combination of optical filters that attenuates specific areas of the visible spectrum corresponding to the peaks of absorption of both the S-cone and rod cells within the human retina. Since previous filters have blocked areas of visible light specifically within the “blue” region, it will be apparent to those skilled in the art that optical systems according to embodiments of the present invention are significantly different from previous filters used for protection or enhancement of vision. Unlike previous filters, for instance, filters according to the present invention are truly phototoxicity blockers on the cellular level. In certain embodiments, the optical filter can be configured to also selectively block at least a portion of light centered at either one or both of the peak absorptive wavelengths of the human M and L-cone cells.

Selective light blocking filters according to the present invention can be included within or on any optical system that is able to transmit all or part of the visible spectrum. For example, it may be used in windows on houses, buildings, cars, trains, boats and many other similar applications. It may also be used in eyeglasses, sunglasses, contact lenses, binoculars, telescopes, light sources, and many other related applications. Additionally, the selective light blocking filters can be applied to camera flashes, fluorescent lighting, LED lighting, other forms of artificial lighting (either to the lighting filament enclosure or the fixture itself), ophthalmic instrumentation such as a retin0scope, ophthalmoscope, fundus camera, bio-microscope and other forms of instrumentation used to view the human eye, computer monitors, television screens, lighted signs or any other similar device.

In one aspect, the present invention provides an optical system including at least one filter configured to selectively block light centered at the peak absorptive wavelengths of the human S-cone cells and the rod cells. As such, the optical system can include a single filter that selectively blocks a portion of light centered at the peak absorptive wavelengths of the human S-cone cells and the rod cells. Alternatively, the optical system can include more than one optical filter. For instance, in one embodiment the optical system includes two filters. In this particular embodiment, one filter selectively blocks light centered at the peak absorptive wavelength of the human S-cone cells and the other filter selectively blocks light centered at the peak absorptive wavelength of the rod cells. Thus, the optical system can include more than one filter in which each individual filter is configured to selectively block a specific wavelength of light. In such a system, the filters collectively block light centered at the peak absorptive wavelengths of the human S-cone cells and the rod cells.

In preferred embodiments, the optical system includes one or more transparent or partially transparent substrates and one or more selective light blocking filters according to the present invention. The optical filter(s) are preferably disposed on the substrate(s). In this particular embodiment, the optical filter(s) selectively block at least a portion of light at any combination of two or more wavelengths selected from 420 nm±9 nm, 498 nm±9 nm, 534 nm±9 mn and 564 nm±9 nm. In one such embodiment, the optical system includes a first selective light blocking filter applied to a first transparent substrate and a second selective light blocking filter applied to the same or a second transparent substrate. The first filter can selectively block light centered at the peaks of absorption of both the S-cone and rod cells within the human retina and the second filter can block light centered at either one or both of the peak absorptive wavelengths of the human M and L-cone cells within the human retina.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 is a diagram that shows the mean absorbance spectra of the four classes of human photoreceptors where the two shaded areas represent an approximation of the two areas to be targeted for blockade;

FIG. 2A is a front view of a double insulating glass unit to which an optical filter according to the present invention could be applied;

FIG. 2B is a cross-sectional view taken along line 2-2 of FIG. 2A;

FIG. 3 shows an optical filter positioned between two substrates in the design of a pair of sunglasses;

FIG. 4 shows a reflectance diagram for an optical filter according to one embodiment of the present invention;

FIG. 5 is a table listing the numerical reflectance values of the reflectance diagram from FIG. 4;

FIG. 6 shows angle sensitivity of reflectance to incident angle of light for the 420 nm peak;

FIG. 7 shows angle sensitivity of reflectance to incident angle of light for the 498 nm peak.

### DETAILED DESCRIPTION OF THE INVENTION

The present invention now will be described more fully hereinafter with reference to the accompanying drawings, in which some, but not all embodiments of the invention are shown. Indeed, aspects of this invention may be embodied in many different forms and should not be construed as limited to the embodiments set forth herein; rather, these embodiments are provided so that this disclosure will satisfy applicable legal requirements. Like numbers refer to like elements throughout.

Since peak damage actually occurs in a bimodal distribution centered around both the 420 nm and 498 nm regions at the apex of the S cone and rod cell absorption curves, the present invention relates to an optical filter that blocks out light centered at these peak sensitivities. As such, filters according to the present invention provide for the filtering of light centered on the most potentially phototoxic areas of the visible spectrum to the eye. While completely blocking one or both of the sensitivity peaks of the S-cones and the rods is possible, embodiments of the present invention preferably allow a percentage of light at these wavelengths to pass in order to help regulate circadian rhythms and decrease risks for clinical depression. Stated differently, optical filters according to the present invention preferably only partially filter these two peaks and the surrounding areas under the absorption curves rather than eliminate all of the light around a particular wavelength.

By attenuating the two parabolic absorption curves of the S-cones and rods by flattening out their steep peaks of absorption with optical filters of the present invention, maximal protection for the eye should be obtained. Further, these optical filters help selectively protect the eye from phototoxicity and potential degenerative visual problems later in life in a similar way to how sunscreen protects the skin from aging and cancer.

Selectively blocking portions of the visible spectrum may initially seem like it would negatively impact color discrimination. However, based on the physiology of vision, the typical use of optical filters according to the present invention should not decrease apparent color vibrancy. For instance, the visual experience all starts with the photoreceptors. If a photoreceptor receives enough energy at a particular wavelength to be activated, it will propagate the electrochemical message to another cell. However, the strength of the propagation signal to the next cell is the same regardless of the amount of initial energy absorbed. In other words, the propagation signal is either all or none. Therefore, the perceived visual signal in the brain ultimately is not more vibrant to our visual system if the initial impetus were of maximal light energy or at the minimal threshold for activation. Therefore, the best way for a photoreceptor to initially receive light energy would be at the minimal energy needed to activate it in order to protect the cell and surrounding tissues from absorbing any unnecessary extra energy that may cause potentially phototoxic reactions. By filtering the peaks of the S-cone and rod receptors according to the present invention, the unnecessary extra energy is removed and does not alter the ability to see full color in even dimly lit photopic conditions.

An afterimage is a good example of how too much light energy absorption is detrimental to real time vision. The most common afterimage people are familiar with is the flashbulb. After a flashbulb goes off, the resultant afterimage arises because the retina effectively absorbs more energy than it can handle. Retinal bleaching occurs and the image of a white flashbulb remains long after the true impetus for the image is gone. This is particularly noticeable in the area of the most intense energy absorption emanating from the flashbulb filament. The ability to see distinct color or discern the surroundings is temporarily diminished when the retina is bleached.

Retinal bleaching likely still occurs at a mild level even during normal physiologic situations in bright light. Adaptive responses occur and our pupils become smaller under intense photopic conditions. Despite these adaptations, the latency period for photoreceptors to reset and send subsequent signals about our changing visual environment is likely increased when light energy exceeds a certain level. A decrease in this photopic bleaching from attenuation of the higher energy S-cone and rod absorption curves therefore increases our ability to see things more quickly. This is because with less bleaching, cellular visual signals can be sent more frequently since cells recover faster. So, in addition to being photoprotective in the long term, any optical system including an optical filter(s) according to the present invention also allows better short-term visualization of the environment by decreasing some of the higher energy light absorption that is unnecessary during almost all parts of the day.

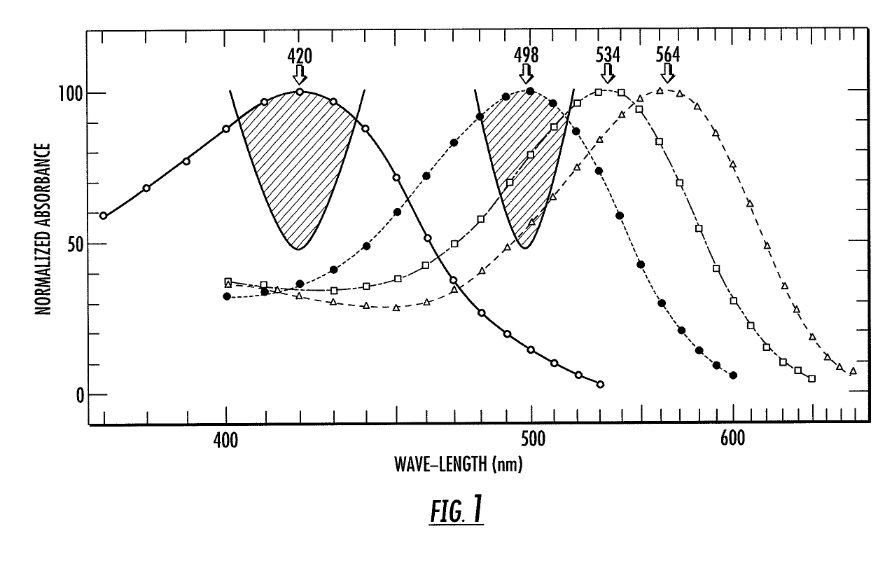

As described above, optical filters according to the present invention provide protection from harmful excess energy at the peak absorption wavelengths of the human S-cone and rod cells while simultaneously providing better short-term visualization by selectively blocking some of the unnecessary higher energy light. More specifically, the optical filters selectively block light centered at approximately the 420 nm (i.e., the peak absorption wavelengths of the human S-cone cells) and 498 nm (i.e., the peak absorption wavelengths of the human rod cells) wavelengths. As shown in FIG. 1, which illustrates the mean absorbance spectra of the four classes of human photoreceptors, the two highest energy absorption curves for the retina are centered at these wavelengths. In FIG. 1, the curve labeled ‘420’ represents the mean of three blue-sensitive cones, the curve labeled ‘498’ represents the mean of eleven rods the curve labeled ‘534’ represents the mean of eleven green-sensitive cones (i.e., M-Cone cells), and the curve labeled ‘564’ represents the mean of nineteen red-sensitive cones (i.e. L-Cone cells). The shaded areas shown in FIG. 1 represent the areas of light blockade according to one embodiment of the present invention. As illustrated in FIG. 1, an optical filter partially attenuates the two parabolic absorption curves of the S-cones and rods by centering the partial blockage of light around 420 nm and 498 nm. Such blockage of light reduces the peak absorptive energy at both parabolic absorption curves of the S-cones and rods. Thus, the optical filters of the present invention selectively reduce and/or eliminate the unnecessary excess energy that is harmful to the human eye.

Although the amount of light blockage illustrated by the shaded areas in FIG. 1 depict a somewhat equal magnitude of filtering on both absorption curves of the S-cones and rods, the amount of light blockage can be varied independently of each other. As merely one example, the absorption curve of the S-cones can be attenuated by blocking about 40 percent of light centered at 420 nm while the absorption curve of the rods can be attenuated by blocking about 10 percent of light centered at 498 nm. Regardless of the respective amounts of light blockage, the center of the blockades should not differ from the diagram shown in FIG. 1 unless further refinements in the exact location of the S-cone and rod cell absorption peaks for humans ever become known.

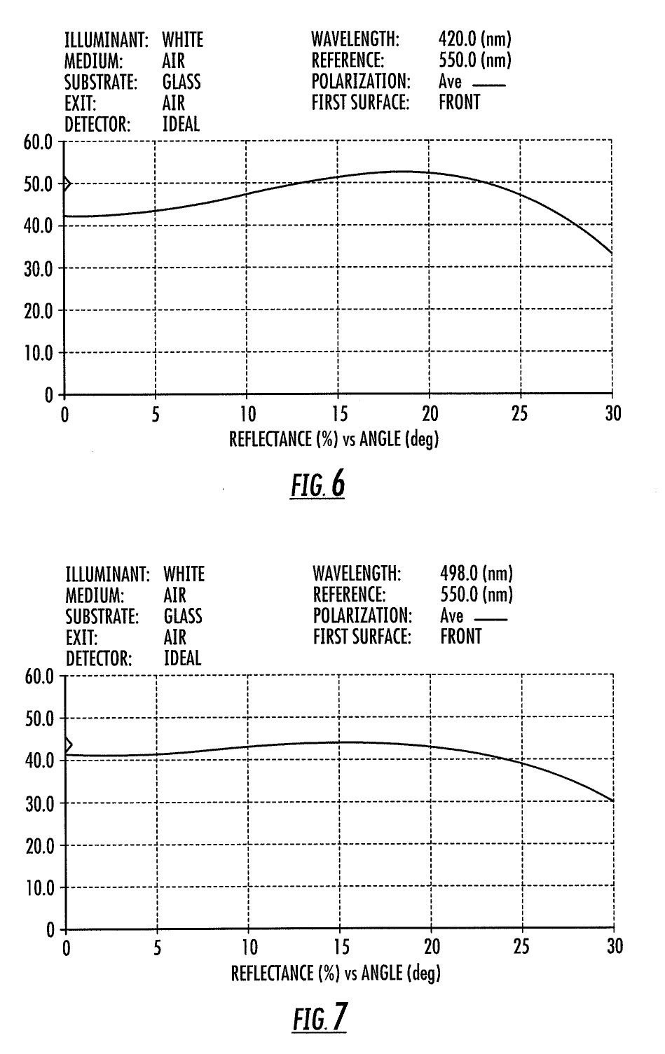

While the spirit of the present invention relates to centering the blockade of light around the wavelengths of 420 nm and 498 nm, occasions may arise where this may have to differ slightly in order to accommodate different filtering modalities required for specific applications. One example could be in a pair of binoculars. Here, the only feasible filter design currently available for incorporation into the binocular lenses may have one of the two peak blockades at 502 nm instead of 498 nm. While this may cause the center of one blockade to be slightly off-center from its ideal, it would likely be close enough to allow for some of the desired effect. Typically, the deviation from the ideal center of attenuation at a desirable incidence angle would be no greater than ±9 nm off of 420 nm and 498 nm. Preferably, the deviation from the ideal center of attenuation at a desirable incidence angle would be no greater than ±5 nm off of 420 nm and 498 nm. Most preferably, the deviation from the ideal center of attenuation at a desirable incidence angle would be no greater than ±3 nm off of 420 nm and 498 nm. Within the spirit of centering the blockade of light around the wavelengths of 420 nm and 498 nm, the blockade may also be referenced with an incidence angle other than zero to maximize its effectiveness over the widest range of incidence angles. Referring to Table 1 provided in paragraph [0051], if the thickness of layer 6 is changed from 312.51 nm to 292.66 nm and the other layers remain the same, the double-notched blockade is centered at 423 nm and 498 nm at zero incidence angle. However, in this particular embodiment of the invention with the changed thickness discussed above, the rate of attenuation loss as incident angles become greater than 20 degrees is significant for the 420 nm and 498 nm wavelengths. In one of the preferred embodiments exemplified in Table 1, the double-notched blockade is centered at 423 nm and 498 nm at a 15 degree incident angle. In this particular embodiment, the blockade of the 420 nm and the 498 nm wavelengths show attenuation (e.g., reflectivity) at a more even slope over a wider range of incident angles as illustrated in FIGS. 6 and 7.

Depending on the different applications of the optical filters of the present invention, there may be a need for a more intense blockade at the peak of the S-Cone absorption curve or a more intense blockade at the peak of the rod absorption curve. By utilizing different filter types, differing percentages of attenuation of the two wavelengths of interest would be possible. For example, the optical filters can block light at the peak absorptive wavelength of the S-Cone cells from 1% to 10%, 20%, 30%, 40%, 50%, 60%, 70%, 80%, 90%, 95% and 99%. Likewise, the optical filters can block light at the peak absorptive wavelength of the rod cells from 1% to 10%, 20%, 30%, 40%, 50%, 60%, 70%, 80%, 90%, 95% and 99%. The degree of attenuation of each absorption curve can be achieved independent of the degree of attenuation of any other absorption curve. Thus, utilizing the large number of potential combination of blockades delivers many possibilities for the design of the filter for several different applications.

In certain alternative embodiments, the optical filters can also include additional blockade at either one or both of the absorption peaks of the M and L-cone cell absorption curves. As illustrated in FIG. 1, the peak absorptive wavelengths of the M and L-cone cells are located at 534 nm and 564 nm, respectively. The optical filters can block light at the peak absorptive wavelength of the M-Cone cells from 1% to 10%, 20%, 30%, 40%, 50%, 60%, 70%, 80%, 90%, 95% and 99%. Likewise, the optical filters can block light at the peak absorptive wavelength of the L-Cone cells from 1% to 10%, 20%, 30%, 40%, 50%, 60%, 70%, 80%, 90%, 95% and 99%. The degree of attenuation of each absorption curve can be achieved independent of the degree of attenuation of any other absorption curve. In these particular embodiments, the additional blockade at either one or both of these locations can be employed to further decrease phototoxicity and decrease unwanted clinical or subclinical afterimage effects. Potentially, such embodiments could be used to increase reaction time in some situations. Although there would be limited protective benefit from blockage at these longer wavelengths, improvement in visual performance is the greater benefit obtained from blocking these additional peaks.

Known techniques for blocking light wavelengths include absorption, reflection, interference, or any combination thereof. According to one technique, a lens may be tinted/dyed with a particular blocking tint, such as BPI Filter Vision 450 or BPI Diamond Dye 500, in a suitable proportion or concentration. The tinting may be accomplished, for example, by immersing the lens in a heated tint pot containing the desired blocking dye solution for some predetermined period of time. According to another technique, a true filter is used for blocking light. The filter can include, for example, organic or inorganic compounds exhibiting absorption and/or reflection of and/or interference with the light wavelengths of interest. Further, the filter can comprise multiple thin layers or coatings of organic and/or inorganic substances. Each layer may have properties, which, either individually or in combination with other layers, absorbs, reflects or interferes with light having the particular light wavelengths to be blocked. Rugate notch filters are one example of light blocking filters. Rugate filters are single thin films of inorganic dielectrics in which the refractive index oscillates continuously between high and low values. Fabricated by the co-deposition of two materials of different refractive index (e.g. SiO₂ and TiO₂), rugate filters are known to have very well defined stop-bands for wavelength blocking, with very little attenuation outside the band. Rugate filters are disclosed in more detail in, for example, U.S. Pat. Nos. 6,984,038 and 7,066,596, each of which is incorporated herein by reference in its entirety. Another technique for blocking light is the use of multi-layer dielectric stacks. Multi-layer dielectric stacks are fabricated by depositing discrete layers of alternating high and low refractive index materials. Similarly to rugate filters, design parameters such as individual layer thickness, individual layer refractive index, and number of layer repetitions determine the performance parameters for multi-layer dielectric stacks. As such, some of the different filter types which can be utilized in different embodiments of the invention include dyes, dichroic filters, multi-layer dielectric stacks, interference filters, laminate filters, notch filters, holographic filters, band-block filters, band-pass filters, rugate filters, polarization interference filters, DWDM filters, rare-earth doped filters, other filters, selective wavelength boosters, or combinations thereof including filters not yet described.

Selective light blocking filters according to the present invention can be included within or on any optical system that is able to transmit all or part of the visible spectrum. In one aspect, the present invention provides an optical system including at least one filter configured to selectively block light centered at the peak absorptive wavelengths of the human S-cone cells and the rod cells. As such, the optical system can include a single filter that selectively blocks a portion of light centered at the peak absorptive wavelengths of the human S-cone cells and the rod cells. Alternatively, the optical system can include more than one optical filter. For instance, in one embodiment the optical system includes two filters. In this particular embodiment, one filter selectively blocks light centered at the peak absorptive wavelength of the human S-cone cells and the other filter selectively blocks light centered at the peak absorptive wavelength of the rod cells. Thus, the optical system can include more than one filter in which each individual filter is configured to selectively block a specific wavelength of light. In such a system, the filters collectively block light centered at the peak absorptive wavelengths of the human S-cone cells and the rod cells.

In other embodiments, the optical system also selectively blocks light centered at either one or both of the peak absorptive wavelengths of the human M and L-cone cells. In some embodiments, the optical system utilizes a single filter configured to selectively block light centered at either one or both of the peak absorptive wavelengths of the human M and L-cone cells in addition to blocking light centered at the peak absorptive wavelengths of the human S-cone cells and the rod cells. Alternatively, the optical system can comprise multiple selective optical filters. In one embodiment, for instance, the optical system can include a first filter that is configured to selectively block light centered at the human S-cone cells and the rod cells and a second filter to selectively block light centered at the human M and L-cone cells. As such, the two filters in this embodiment collectively block light centered at the peak absorptive wavelengths of the human S-cone cells and the rod cells and the human M and L-cone cells. In similar embodiments, the optical system includes multiple optical filters in which each filter is configured to specifically block a portion of light from a particular wavelength of interest. For example, the optical system can include a first filter configured to selectively block a portion of light centered around 420 nm, a second filter configured to selectively block a portion of light centered around 498 nm, a third filter configured to selectively block a portion of light centered around 534 nm, and optionally a fourth filter configured to selectively block a portion of light centered around 564 nm. In such embodiments, the optical filters collectively block light at every wavelength of interest. Accordingly, embodiments of the invention comprise optical systems that include one or more selective light blocking filters that selectively block at least a portion of light at any combination of two or more wavelengths selected from 420 nm, 498 nm, 534 nm, and 564 nm.

In preferred embodiments, the optical system includes one or more transparent or partially transparent substrates and one or more selective light blocking filters according to the present invention. The optical filter(s) are preferably disposed on/adjacent or proximate to the substrate(s). For example, an optical filter according to the present invention can be directly applied or deposited onto the substrate. Alternatively, a color balancing film or the like can be applied directly to the substrate and an optical filter according to the present invention can be applied over the top of the color balancing film. As such, the optical filter is indirectly attached and proximately located to the substrate. In various embodiments, an optical filter(s) according to the present invention can be provided or located within a series of coatings or filters adjacent to the substrate. As used herein, a “transparent substrate” should be understood as a material capable of transmitting light so that objects or images can be seen as if there were no intervening material. Further, the term “partially transparent substrate” should be understood as allowing at least some light to pass through diffusely. As such, substrates suitable for use in the present invention include a full range of materials that allow complete transmittance of light to materials that block a vast majority of light. For instance, the optical filters can be used on any modality that has at least partial light transmission including one-way mirrors, acrylics, other plastics, and any organic or inorganic material capable of transmitting light.

In one alternative embodiment, the optical system can include multiple substrates comprising a combination of lenses and mirrors. In such embodiments, an individual optical filter according to the present invention can be applied on/adjacent or proximate to any of the lenses or mirrors that will define the path of light to a human eye. Alternatively, the optical system can include multiple filters in which one of the lenses is directly or indirectly coated with an optical filter according to the present invention and another filter according to the present invention is directly or indirectly coated onto a mirror. In such embodiments, the lens(es) and mirror(s) typically define a path of light. As such, in embodiments having a first filter applied to a transparent lens and a second filter applied to a one-way mirror, the two filters are said to be in-line with each other.

In one particular embodiment, the optical filter(s) incorporated into an optical system are configured to selectively block at least a portion of light at any combination of two or more wavelengths selected from 420 nm±nm, 498 nm±9 nm, 534 nm±9 nm and 564 nm±9 nm. In one such embodiment, the optical system includes a first selective light blocking filter applied to a first transparent substrate and a second selective light blocking filter applied to the same or a second transparent substrate. The first filter can selectively block light centered at the peaks of absorption of both the S-cone and rod cells within the human retina and the second filter can block light centered at either one or both of the peak absorptive wavelengths of the human M and L-cone cells within the human retina. Alternatively, an embodiment of the present invention comprises a single optical filter configured to selectively block at least a portion of light at any combination of two or more wavelengths selected from 420 nm±nm, 498 nm±9 nm, 534 nm±9 nm and 564 nm±9 nm.

As described previously, any filtering modality could be utilized for the invention to create attenuation of light centered at the 420 nm and 498 nm wavelengths (and optionally centered at 534 nm and 564 nm). Also, the optical filter can utilize any percentage of attenuation ranging from 0 to 100% blockage for either the 420 nm or 498 nm wavelengths (and optionally centered at 534 nm and 564 nm wavelengths). In unlikely circumstances, it may be beneficial to employ a filter configured to provide a 0% blockage at one of the attenuation points when a higher risk of double blockade (filtering the same light twice before light reaches the eye) exists for a particular application of the present invention. Some of the different filter types which can be utilized in different embodiments of the invention include dyes, dichroic filters, multi-layer dielectric stacks, interference filters, laminate filters, notch filters, holographic filters, band-block filters, band-pass filters, rugate filters, polarization interference filters, DWDM filters, rare-earth doped filters, other filters, selective wavelength boosters, or combinations thereof including filters not yet described.

In any non-opaque optical system used to attenuate the peak wavelengths described above, there will be a slight change from a color neutral appearance if looking at the optical filter as an observer rather than looking through the filter. Analyzing the total color difference that the filter creates and using a second filter or dye or doped material to cancel out any color difference can change this effect. Color neutrality or color balancing would likely be important in the case of window applications in houses or buildings, but may also be desirable in glasses or sunglasses or any other optical system where the phototoxicity filter is used. Accordingly, embodiments of the present invention can provide effective attenuation of the peak absorptive curves of interest in combination with color balancing. “Color balancing” or “color balanced” as used herein means that the non-white or non-clear color, or other potential unwanted effect of blocking light is reduced, offset, neutralized or otherwise compensated for so as to produce a cosmetically acceptable result, without at the same time reducing the effectiveness of protecting the eye. Additionally, to an external viewer, the optical system looks clear or mostly clear. For an individual using an optical system according to the invention, color perception is normal or acceptable.

In one embodiment, color balancing comprises imparting, for example, a suitable proportion or concentration of blue tinting/dye, or a suitable combination of red and green tinting/dyes to the color-balancing component, such that when viewed by an external observer, the optical system as a whole has a cosmetically acceptable appearance. For example, the optical system as a whole should look clear or mostly clear.

In addition to color-balancing components, the optical filters according to embodiments of the present invention can be used in combination with any other adjacent or non-adjacent coatings or filters. Examples of such coatings or filters include, but are not limited to, anti-reflective coatings, waterproof coatings, reflective and anti-reflective coatings, mirrors, color tinting filters or dyes or doped material, color neutralizing filters or dyes or doped material, polarization films or coatings, anti-glare coatings, anti-scratch or scratch resistant coatings, and any other similar coatings or combinations thereof. The filters according to the present invention can also be used in combination with any adjacent or non-adjacent optical filters that could potentially further protect the eye or are designed for improvement of vision or any other visual purpose.

As referenced above, the selective light blocking filters according to the present invention can be included within or on any optical system that is able to transmit all or part of the visible spectrum. For example, it may be used in windows on houses, buildings, cars, trains, boats, trains, helicopters, planes and many other similar applications. This could be accomplished utilizing any type of window design. With the application of the filter on a typical automobile windshield, the filter would be ideally deposited on the inside surface of the exterior piece of glass/substrate, within the dividing plastic layer in a shatterproof windshield, or on the inside surface of the interior piece of glass/substrate. However, the optical coating or dyed or doped material could be located anywhere within the window assembly.

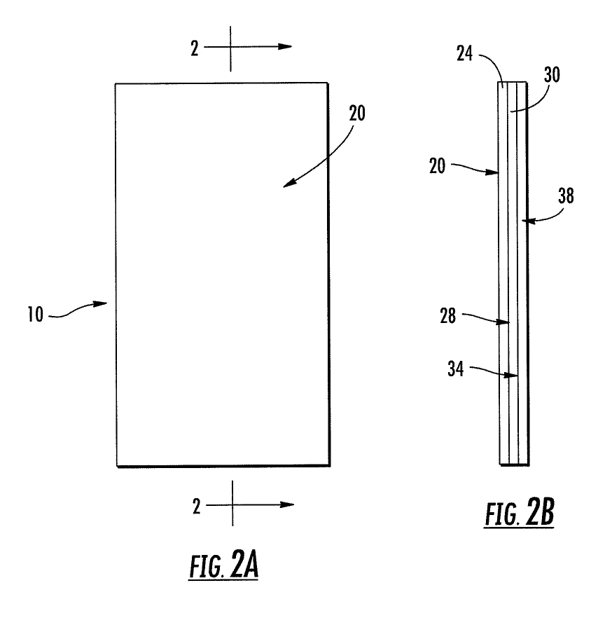

As discussed above, the optical filters of the present invention can be incorporated into a wide variety of optical systems, such as windows, light emitting devices and optical viewing systems to name a few. FIG. 2A shows front view of a double insulating glass unit 10 suitable as a window for residential or commercial use. From the front view, only the front surface 20 of the front windowpane 24 is viewable. However, FIG. 2B shows a cross-sectional view of the double insulating glass unit 10 including a front windowpane 24 and a rear windowpane 38. Preferably, an insulting gas 30 is provided between the front windowpane 24 and the rear windowpane 38. In this particular embodiment, an energy efficient coating is deposited on the inner surface 28 of the front windowpane 24. The rear windowpane's 38 inner surface 34 is coated with a phototoxicity filter according to the present invention. As such, FIG. 2 illustrates one embodiment in which an optical filter of the present invention is incorporated into an optical system (e.g., a window). Although a double insulating glass unit is shown, there are many alternative ways to create this same filtering effect and many other types of windows where the filtering could be accomplished. For example, the same protective blockage of light can be achieved with a triple insulating glass unit, a non-insulating single pane window, and any other type of window through multiple filtering techniques. Any window designed for commercial use, either on a building or not, would also be able to incorporate one or more filters of the present invention.

In addition to window applications, the optical filter can also be used on materials surrounding or adjacent to light emitting devices. For instance, the selective light blocking filters can be applied to camera flashes, fluorescent lighting, LED lighting, ophthalmic instrumentation such as a retinoscope, ophthalmoscope, fundus camera, bio-microscope and other forms of instrumentation used to view the human eye, computer monitors, television screens, lighted signs or any other similar device. Other suitable light emitting devices include all types of light bulbs such as halogen, incandescent, and fluorescent bulbs. All of these devices and other light emitting modalities can have the filter incorporated within their design. Lasers, stadium lighting, photography lighting, film lighting, flashbulbs, and spotlights would likely cause some significant risk of phototoxicity to an observer and the filter(s) would likely be of significant benefit in these settings. As merely one example, an optical filter according to the present invention can be applied on the inside surface of a spotlight cover.

Optical filters according to the present invention can also be included within any optical viewing system. This includes use in telescopes, binoculars, magnifying lenses, microscopes, photographic lenses, or any other viewing system. In a microscope, there are typically two lenses where the path of light goes before it reaches the viewer. The filter could be placed on or within any lens, mirror, prism or other component along the light pathway to protect the viewer. To protect the recipient of light from an operating microscope during eye surgery, ideally the filter could be placed on or within a cover over the actual illuminating light source. In an application where a high potential for phototoxicity from light rays occurs, as with an operating microscope, a higher percentage of blockade than usual at the peaks of the S-cone and rod absorption curves may be particularly valuable. For any optical viewing system, the placement of either an optical coating or a dyed or a doped substrate anywhere along a light path to create the desired filtering effect is within the scope of the present invention.

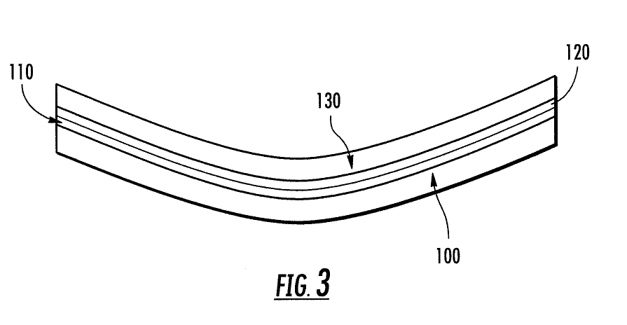

In another embodiment, the optical filter is incorporated into the design of eyeglasses. Such embodiments include prescription glasses for correcting refractive error as well as non-prescription eyeglasses such as safety glasses or sunglasses. In one embodiment, an optical filter is configured to provide the desired blockade and is integrated into an anti-reflective coating and deposited onto the lens of the glasses. However, the filter can be deposited in a variety of other ways. FIG. 3 shows one embodiment in which an optical filter according to the present invention is incorporated into the design of polarized sunglasses. In this embodiment, the back surface of the front substrate/lens 100 is coated with a polarizing material 110. The optical interference coating/filter 120 according to the present invention is then sandwiched between both the back substrate/lens 130 and the polarizing material 110. Although a polarized optical system is described, one or more optical filters of the present invention can be incorporated into both polarized and non-polarized sunglasses as well as other types of eyewear. Further, the present filters can be used in combination with other types of optical filters deposited within their respective optical systems to achieve the desired attenuation of light.

In another embodiment, the optical system comprises a contact lens for the human eye, in which the contact lens includes an optical filter according to the present invention. In such embodiments, the contact lens can include multiple types of contact lenses including soft contact lenses, hard contact lenses, scleral lenses, and any other similar lenses or combinations thereof. Due to the lack of rigidity in soft contact lenses, typical optical interference coatings such as a TiO₂/SiO₂ stack do not adhere as well as they do on rigid materials. Therefore, while many filter designs are theoretically possible, a dyed material is the preferable filter to achieve the desired blockade of light within a soft contact lens optical system. For hard contact lenses, scleral lenses, hard/soft contact lens combinations (hybrids), and other types of rigid contacts, additional possibilities for utilization of a variety of different filtering modalities for the invention become more easily manifest.

In yet another embodiment, the optical system comprises an intraocular lens (IOL), in which an optical filter(s) is applied thereto. The optical filters according to the present invention can be used with any intraocular lens (IOL) type, whether a phakic intraocular lens or not. While there are instances where the invention is ideal in this situation, there are also some scenarios where the filter may not be ideal. If a person has the filter installed in all the windows they look through at their home and place of work, then an intraocular lens would potentially double the intended blockade of the filter because the light would be filtered twice before it reached the back of the eye (once through the window and once through the IOL). While a contact lens or pair of glasses can be easily removed by its owner, an IOL cannot be removed without a surgeon. Therefore, an unintended double blockade could not be easily reversed in this setting. Furthermore, if a state, federal, or foreign mandate ever existed on including the filter on all windows used in new commercial or home construction, the double blockade state would become even more pervasive to an owner of a filtered IOL. Additionally, while the rod absorption peak at 498 nm is technically a blockade centered on the “green” spectrum (1: American Heritage Dictionary of the English Language: Fourth Edition, 2000. 2: Bohren, Fundamentals of Atmospheric Radiation: An Introduction with 400 Problems; Wiley-VCH 2006:213), this “green” area of peak rod absorption is also the most sensitive area in the electromagnetic spectrum for scotopic vision. While mild blockade of peak rod absorption is protective and should not significantly affect the ability to see the color green or night vision, an unintended double blockade could potentially decrease clinical scotopic sensitivity slightly if a person's vision were particularly susceptible to small changes in light intensity. In the case of a filter set in a car windshield, double blockade from additional IOL filtering may be particularly sub-optimal at night. Ultimately, a filtering IOL can be an excellent embodiment of the present invention, and any filtering modality available can be utilized, but implantation of the IOL would always need to be done with caution by the surgeon because of its permanence.

### EXAMPLES

An optical interference coating comprising a 14-layer TiO₂/SiO₂ dielectric stack was created on a thin film software program (i.e., TFCalc 3.5.11 from Software Spectra, Inc.) commonly used by those skilled in the art. The thicknesses of the materials to be added on the thin film filter are provided in Table 1. More specifically, Table 1 lists the thickness of the layers from 1-14 using alternating depositions of both TIO₂ and SIO₂ materials. Deposition can be achieved by physical vapor deposition or other methods which are known to be readily understood by those skilled in the art.

TABLE 1
Material thickness data for a 14-layer TiO₂/SiO₂ dielectric stack

| Layer | Material | Thickness (nm) |
|---|---|---|
| 1 | TIO2 | 10.11 |
| 2 | SIO2 | 291.59 |
| 3 | TIO2 | 12.90 |
| 4 | SIO2 | 205.72 |
| 5 | TIO2 | 13.34 |
| 6 | SIO2 | 312.51 |
| 7 | TIO2 | 10.02 |
| 8 | SIO2 | 124.39 |
| 9 | TIO2 | 10.12 |
| 10 | SIO2 | 325.98 |
| 11 | TIO2 | 10.17 |
| 12 | SIO2 | 230.77 |
| 13 | TIO2 | 14.69 |
| 14 | SIO2 | 125.12 |

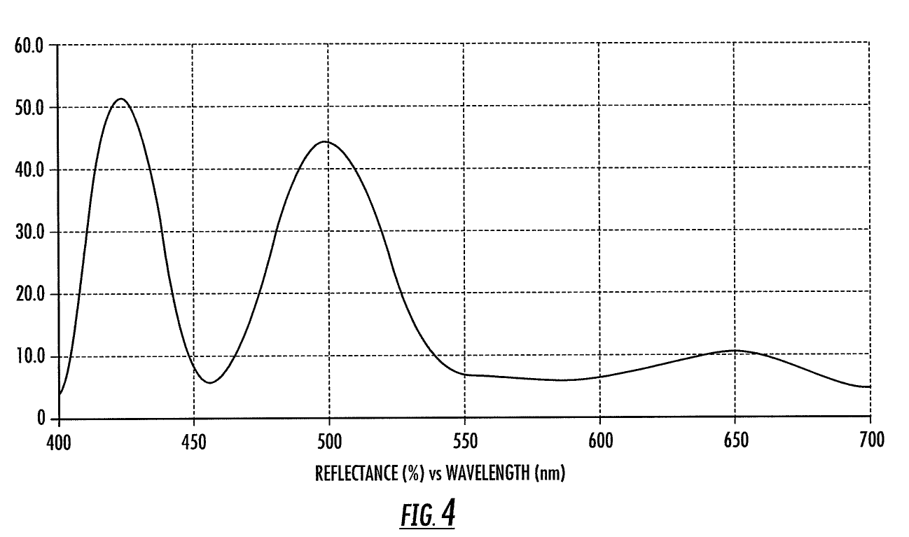

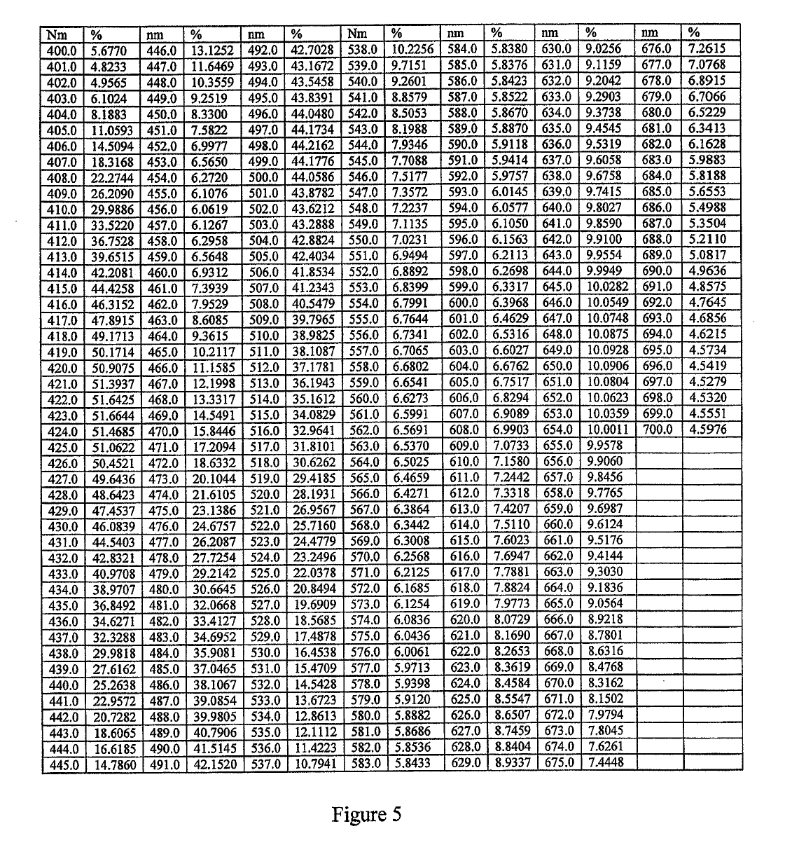

The spectral reflectance diagram for the filter in the form of an optical interference coating described above (i.e., the 14-layer TiO₂/SiO₂ dielectric stack) is provided in FIG. 4. FIG. 5 provides a listing of the numerical reflectance values of the reflectance diagram from FIG. 4 at a 15-degree incident angle. As illustrated by FIGS. 4 and 5, the optical filter selectively blocks light centered at wavelengths of 423 nm and 498 nm. Specifically, about 51.7% of the light at a wavelength of 423 nm was reflected and not allowed to pass through the filter. Similarly, about 44.2% of the light at a wavelength of 498 nm was reflected and not allowed to pass through the filter. In this embodiment, the rod peak is attenuated less than the S-cone peak because of the decreased relative contribution of phototoxicity from the rods. Of further importance, the optical filter appears to exhibit a negligible impact of the transmittance of light at other wavelengths.

FIGS. 6 and 7 illustrate the variance in reflectance percentage using the 14-layer filter as a function of the incident angle of light from zero to 30 degrees at 420 nm and 498 nm wavelengths target, respectively. As shown in FIGS. 6 and 7, there is some minor angle sensitivity noted, but overall the filter exhibits significant angle insensitivity.

Accordingly, this 14-layer coating could be applied in the location indicated for an optical filter in FIG. 2 and in numerous other locations. If applied sandwiched between two lenses 110, 130 as illustrated in FIG. 3, the 14-layer stack would have to be modified slightly to account for the change in index of refraction. If applied on the outer/convex surface of the front (farthest away from the eye) lens 100 of FIG. 3, the 14-layer coating would not have to be modified from the thicknesses listed in Table 1. The 14-layer stack can be achieved using multiple thin-film deposition methods including physical vapor deposition (PVD). The deposition processes used to create thin-films are well known by those skilled in the art. Again, multiple other filtering modalities can be used in accordance with embodiments of the invention to achieve a similar reflectance diagram with peak attenuation centered at 420 nm±9 nm and 498 nm±9 nm. Multiple methods can also be used to change the amplitude of sensitivity to incidence angle at the attenuation peaks as well.

Many modifications and other embodiments of the invention set forth herein will come to mind to one skilled in the art to which this invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

1. An optical filter configured to selectively block light centered at the peak absorptive wavelengths of the human S-cone cells and the rod cells.

2. The optical filter according to claim 1, wherein the filter is configured to also selectively block light centered at either one or both of the peak absorptive wavelengths of the human M and L-cone cells.

3. An optical system comprising one or more filters configured to individually or collectively selectively block light centered at the peak absorptive wavelengths of the human S-cone cells and the rod cells.

4. The optical system of claim 3, comprising a first filter and a second filter, wherein the first filter selectively blocks light centered at the peak absorptive wavelength of the human S-cone cells and the second filter selectively blocks light centered at the peak absorptive wavelength of the rod cells.

5. The optical system of claim 3, comprising a single filter that selectively blocks light centered at the peak absorptive wavelengths of the human S-cone cells and the rod cells.

6. The optical system of claim 5, wherein the filter selectively blocks light at 420 nm +/−9 nm and 498 nm +/−9 nm.

7. The optical system of claim 5, wherein the filter selectively blocks light at 420 nm +/−5 nm and 498 nm +/−5 nm.

8. The optical system of claim 5, wherein the filter selectively blocks light at 420 nm +/−3 nm and 498 nm +/−3 nm

9. The optical system of claim 5, wherein the filter blocks from 1% to 95% of light at 420 nm +/−9 nm and from 1% to 95% of light at 498 nm +/−9 nm.

10. The optical system of claim 9, wherein the filter blocks from 1% to 50% of light at 420 nm +/−9 nm.

11. The optical system of claim 9, wherein the filter blocks from 1% to 50% of light at 498 nm +/−9 nm.

12. The optical system of claim 9, wherein the filter blocks from 1% to 50% of light at 420 nm +/−9 nm and from 1% to 50% of light at 498 nm +/−9 nm.

13. The optical system of claim 3, wherein the one or more filters either individually or collectively also selectively blocks light centered at either one or both of the peak absorptive wavelengths of the human M and L-cone cells.

14. The optical system of claim 13, wherein the filter selectively blocks light at 420 nm +/−9 nm, 498 nm +/−9 nm, and either 534 nm +/−9 nm or 564 nm +/−9 nm.

15. The optical system of claim 13, wherein the filter selectively blocks light at 420 nm +/−9 nm, 498 nm +/−9 nm, 534 nm +/−9 nm and 564 nm +/−9 nm.

16. The optical system of claim 3, further comprising a transparent or partially transparent substrate, wherein the filter is located on or proximate to the substrate.

17. The optical system of claim 16, wherein the substrate comprises a window.

18. The optical system of claim 17, wherein the substrate comprises a window for an automobile, a boat, a train, or a commercial building.

19. The optical system of claim 16, wherein the substrate comprises a photographic lens.

20. The optical system of claim 16, wherein the substrate comprises a lens for prescription eyewear used to correct refractive errors.

21. The optical system of claim 16, wherein the substrate comprises a lens for non-prescription eyewear.

22. The optical system of claim 21, wherein the non-prescription eyewear comprises safety glasses, safety goggles, a safety shield, or sunglasses.

23. The optical system of claim 16, wherein the substrate comprises a material surrounding or proximately located to a light emitting device.

24. The optical system of claim 23, wherein the light emitting device is selected from a halogen light bulb, incandescent light bulb, fluorescent light bulb, flash bulb, a laser, monitors, light emitting diode, or television screens.

25. The optical system of claim 16, wherein the substrate comprises a lens disposed within an optical viewing system.

26. The optical system of claim 25, wherein the optical viewing system is selected from a telescope, binoculars, and a microscope.

27. The optical system of claim 16, wherein the substrate comprises a contact lens.

28. The optical system of claim 27, wherein the contact lens is selected from hard contact lenses, soft contact lenses, scleral lenses, or hybrid lenses.

29. The optical system of claim 16, wherein the substrate comprises an intraocular lens.

30. The optical system of claim 3, further comprising a transparent or partially transparent substrate and a color balancing film, wherein the filter and color balancing film are located on or proximate with the substrate.

31. The optical system of claim 30, wherein the color balancing film is selected from color tinting filters, dyes, or doped materials.

32. The optical system of claim 30, wherein the color balancing film is selected from color neutralizing filters, dyes or doped material.

33. The optical system of claim 3, wherein the one or more filters are selected from the group consisting of dyes, dichroic filters, multi-layer dielectric stacks, interference filters, laminate filters, notch filters, holographic filters, band-block filters, band-pass filters, rugate filters, polarization interference filters, DWDM filters, rare-earth doped filters, selective wavelength boosters, or combinations thereof.

34. The optical system of claim 3, further comprising a coating selected from the group consisting of waterproof coatings, reflective and anti-reflective coatings, polarization films or coatings, anti-glare coatings, anti-scratch or scratch resistant coatings, and combinations thereof.

35. An optical system, comprising:
one or more transparent or partially transparent substrates; and
one or more selective light blocking filters disposed directly or indirectly on the one or more substrates, wherein the one or more light filters selectively block at least a portion of light at any combination of two or more wavelengths selected from 420 nm +/−9 nm, 498 nm +/−9 nm, 534 nm +/−9 nm and 564 nm +/−9 nm.

36. The optical system of claim 35, wherein the one or more filters selectively blocks from 1% to 100% of light at any combination of two or more wavelengths selected from 420 nm +/−9 nm, 498 nm +/−9 nm, 534 nm +/−9 nm and 564 nm +/−9 nm.

37. The optical system of claim 36, wherein the one or more filters selectively blocks from 1% to 50% of light at any combination of two or more wavelengths selected from 420 nm +/−9 nm, 498 nm +/−9 nm, 534 nm +/−9 nm and 564 nm +/−9 nm.

38. The optical system of claim 36, wherein the one or more filters selectively blocks from 1% to 50% of light at any combination of two or more wavelengths selected from 420 nm +/−3 nm, 498 nm +/−3 nm, 534 nm +/−3 nm and 564 nm +/−3 nm

39. The optical system of claim 35, further comprising a mirror, wherein the one or more selective light blocking filters is disposed directly or indirectly on the mirror.

40. The optical system of claim 39, wherein the mirror is disposed within an optical viewing system.

41. The optical system of claim 35, wherein the one or more transparent or partially transparent substrates comprises a prescription or non-prescription eyewear lens.

42. The optical system of claim 35, wherein the one or more transparent or partially transparent substrates comprises a material surrounding or proximately located to a light emitting device.

43. The optical system of claim 35, wherein the one or more transparent or partially transparent substrates comprises a window.

44. The optical system of claim 35, wherein the one or more transparent or partially transparent substrates comprises a window for an automobile, a boat, a train, or a commercial building.

45. An optical lens, comprising:
a transparent or partially transparent substrate comprising a first side surface and a second side surface;
a selective light blocking filter comprising a film, wherein the film is configured to selectively block at least a portion of light at any combination of two or more wavelengths selected from 420 nm +/−9 nm, 498 nm +/−9 nm, 534 nm +/−9 nm and 564 nm +/−9 nm; and
a color balancing component configured to cause the optical lens to appear clear or mostly clear;
wherein the filter and the color balancing component are each positioned proximate or adjacent to the substrate.

46. The optical lens of claim 45, wherein the selective light blocking filter is positioned adjacent to the first side surface of the substrate and the color balancing component is positioned adjacent to the second side surface of the substrate.

47. The optical lens of claim 45, wherein the selective light blocking filter is positioned adjacent to the first side surface of the substrate and the color balancing component is positioned adjacent to the selective light blocking filter.
